(19) United States
(12) Patent Application Publication
(10) Pub. No.: US 2006/0102857 A1
(43) Pub. Date: May 18, 2006

(54) Measurement device

(76) Inventors: Richard J. Simpkins, Bloomington, IL (US); William J. Sagy SR., Normal, IL (US)

Correspondence Address: HARNESS, DICKEY & PIERCE, P.L.C., P.O. BOX 828, BLOOMFIELD HILLS, MI, 48303, US

(21) Appl. No.: 11/233,395

(22) Filed: Sep. 22, 2005

Related U.S. Application Data
(60) Provisional application No. 60/612,771, filed on Sep. 24, 2004.

(51) Int. Cl. G01N 21/86

(52) U.S. Cl. 250/559.19

(57) ABSTRACT

A measurement device is presented. The measurement device is pointed at a surface of an object. A message is generated that warns a user when the measurement device is substantially close to exceeding its operating range for obtaining accurate measurement data. The warning may be a verbal warning, a physical warning, or a visual warning.

### CROSS REFERENCE TO RELATED APPLICATIONS

This application claims priority to U.S. Provisional Patent Application Ser. No. 60/612,771, filed Sep. 24, 2004, the disclosure of which is incorporated by reference herein.

### BACKGROUND AND SUMMARY OF THE INVENTION

The present invention relates generally to a measurement device. More particularly, the present invention relates to a measurement device that warns a user before the device operates in a range in which inaccurate data may be obtained.

Throughout a variety of industries, it is frequently necessary to obtain extremely accurate measurement data between an object and a laser measurement device. For example, the automotive industry requires measurement of a gap between a convertible roof's side rail casting and a weather strip retainer. The weather strip retainer supports the weather strip that prevents water from entering the vehicle during inclement weather. If the weather strip retainer fails to adequately protrude far enough away from the side rail casting, the convertible roof will not properly close onto the door glass.

Typically, a laser measurement device is used to measure the gap that exists between the side rail casting and the weather strip retainer. The laser measurement device has an operating range of about 70 millimeter (mm) to 200 mm from the surface of an object. However, laser measurement devices fail to adequately warn a user when inaccurate data is generated. For example, while these devices emit a beeping sound that distinguishes between close and long distance ranges, there is no warning to the user when the device is approaching or initially exceeds its operating range. This is problematic because the laser measurement device may gather inaccurate data that could result in an undesirable appearance and function in the assembly of the vehicle.

In accordance with the present invention, a measurement device is provided. One aspect of the present invention involves pointing the measurement device at an object. In another aspect of the present invention, an angle or a distance is measured between the measurement device and the object. In yet another aspect of the present invention, a message is generated that warns a user when the measurement device is substantially close to exceeding its operating range for obtaining accurate measurement data. An automotive convertible roof is measured with a device in a further aspect of the present invention.

The present invention involves a measurement device that warns a user when it is close to exceeding its operating range. This is advantageous since it allows the user to adjust the distance or angle between the measurement device and the surface of the object. This ensures that adequate measurement data is continuously obtained. Higher quality and more repeatable part assembly, especially for convertible roofs, is thereby achieved with the present invention. Additional advantages and features of the present invention will become apparent from the following description and appended claims, taken in conjunction with the accompanying drawings.

### BRIEF DESCRIPTION OF THE DRAWINGS

The present invention will become more fully understood from the detailed description and the accompanying drawings, wherein:

FIG. 1 is a perspective view of a portable measurement device of the present invention;

FIG. 2 is a block diagram of components of a measurement device of the present invention;

FIG. 3 is a fragmentary and perspective side view of a convertible roof of the present invention;

FIG. 4 is an enlarged view, taken within circle 4 of FIG. 3, showing the perspective side view of a convertible roof;

FIG. 5 is a fragmentary and perspective side view of a convertible roof and measurement device of the present invention;

FIG. 6 is an enlarged view, taken within circle 6 of FIG. 5, showing the perspective side view of a convertible roof;

FIG. 7 is a diagrammatic end view of an exemplary workpiece with a gap that is to be measured;

FIG. 8 is a diagrammatic end view showing an exemplary measurement device that measures a gap in a workpiece;

FIG. 9 is a view illustrating a scanning system range for a measurement device of the present invention; and

FIG. 10 is a flow diagram illustrating a method of warning a user of a measurement device before inaccurate measurement data is obtained.

### DETAILED DESCRIPTION OF THE PREFERRED EMBODIMENTS

The following description of the preferred embodiments is merely exemplary in nature and is in no way intended to limit the invention, its application, or uses. For purposes of clarity, the same reference numbers are used in the drawings to identify similar elements. As used herein, the term “module” refers to an application specific integrated circuit (ASIC), an electronic circuit, a processor (shared, dedicated, or group) and memory that execute one or more software or firmware programs, a combinational logic circuit, or other suitable components that provide the described functionality.

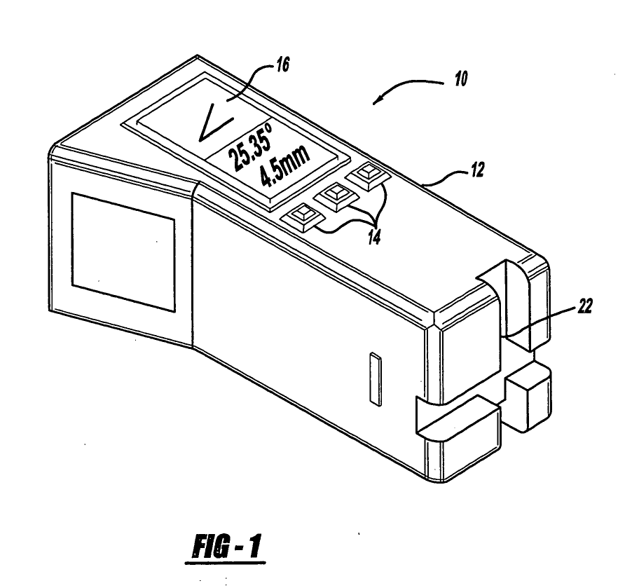

FIG. 1 is a perspective view of a portable measurement device 10. Measurement device 10 is housed in a housing assembly 12 that is configured to be hand-held by a user. The operation of measurement device 10 may be controlled through the user interface elements integrated into housing assembly 12. Additionally, one or more push buttons 14 are located on measurement device 10. These push buttons 14 receive input from the user. A display 16 visually outputs measurement data to the user.

In one embodiment, measurement device 10 uses measurement technologies such as laser triangulation technology. Generally, a non-contact sensor 22 of measurement device 10 projects one or more planes of laser light towards an object or workpiece. The laser plane is projected by a light source assembly (not shown) that may include a laser diode, a laser projection lens assembly and accompanying electronics for controlling the light source assembly. The points of intersection of the projected laser plane and the object are then imaged by an electronic camera assembly. The electronic camera assembly includes an imaging array (e.g., CCD, CMOS, etc.), a lens assembly, and associated electronics for controlling the electronic camera assembly.

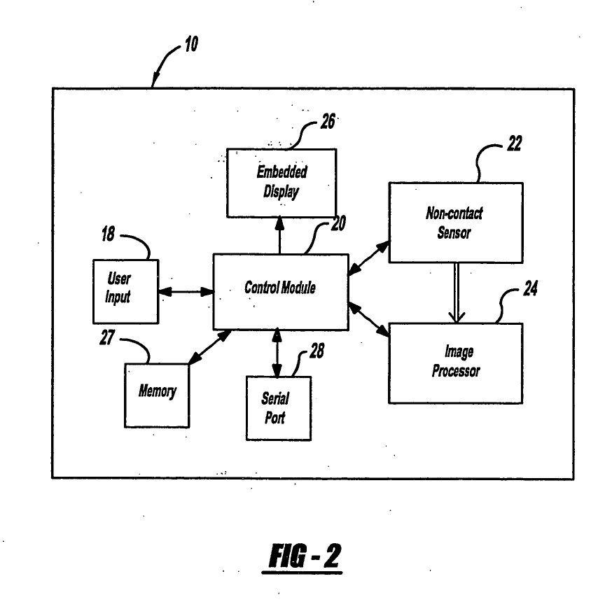

FIG. 2 illustrates the basic components associated with the measurement device 10. The measurement device 10 generally includes one or more user input elements 18, a control module 20, a non-contact sensor 22, an image processor 24, a display 26, a memory 27, and a power supply (e.g., a battery). One or more user input elements 18 receive input commands from a user of the measurement device 10. Input commands may include power on/off commands, measurement trigger commands, measurement mode commands, measurement origin offset commands, etc. The input commands are in turn communicated to the control module 20. The user input elements 18 may assume a variety of forms, including push buttons, radial knobs, a touch screen display, or a combination thereof.

The control module 20 controls the operation of the measurement device 10. For example, the control module 20 interfaces with the non-contact sensor 22 to facilitate acquisition of image data for a measured distance or angularity. The control module 20 also interfaces with the image processor 24. The image processor 24 retrieves image data from the non-contact sensor 22 and converts the image data into measurement data for the measured area. Once this data is obtained, the control module 20 compares the measured distance or angle to the known operating range for the measurement device 10. The operating range is accessed from the memory 27 by the control module 20. If the measured distance or angle is substantially close to exceeding the operating range of the measurement device 10, the control module 20 issues a warning command. For example, a warning command may be issued when the measured distance or angle is within 85% of the upper or lower limit of the operating range for the measurement device 10. This warning command may require that the measurement device 10 generate an audible warning, a visual warning on the display 26, and/or a physical warning (e.g., vibrating motion). The audible warning may be a beep, a verbal warning or other suitable sounds.

A display 26 embedded into the housing of the measurement device is used to visually display the measurement data or to warn the user. To do so, the display 26 is adapted to receive measurement data from the image processor 24. In addition, the display 26 may further receive input commands from the control module 20 as to how the dimensional data is to be displayed to the user. The display 26 may be graphic or numeric and assume a variety of forms (e.g., LED, LCD, etc.).

The portable measurement device 10 may optionally include an external communication port 28 (e.g., RS-322, USB, wireless port, etc). The control module 20 optionally transmits measurement data via the communication port 28 to an external source. In addition, the control module 20 may also receive remote activation commands or updates to the software algorithms via the communication port 28 from an external source. Other aspects of the manner in which a measurement device 10 operates may be found in U.S. Pat. No. 6,717,166, issued to Pease on Apr. 6, 2004, which is incorporated herein by reference.

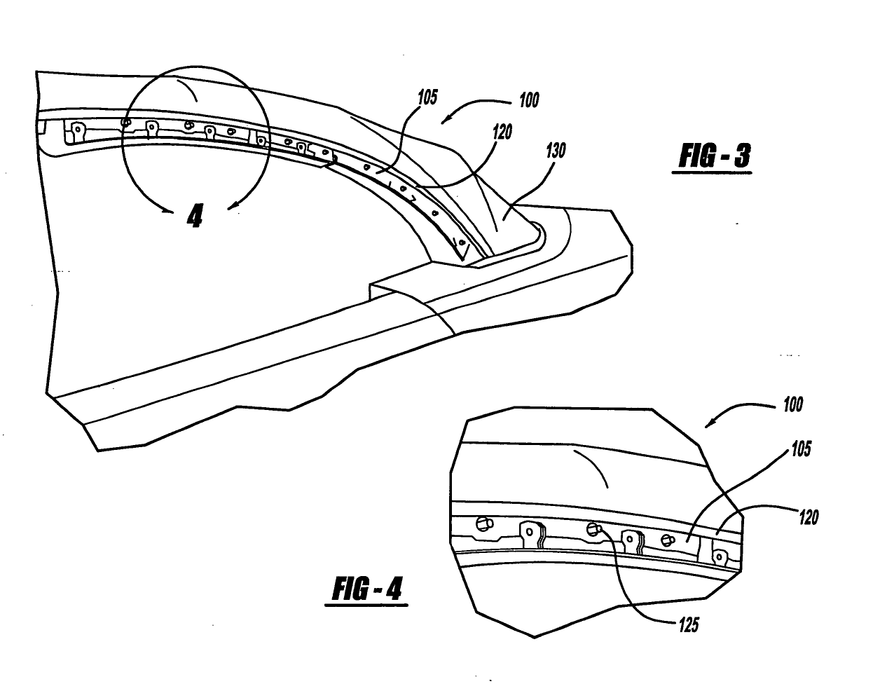

Referring now to FIG. 3, a side view of a convertible roof 100 is shown with a side rail casting 105 and to a retractable arm 120. The retractable arm 120 is attached to the convertible roof 100. The retractable arm 120 is used to open and to close the convertible roof 100. A more detailed description of a convertible roof top 100 mechanism for opening and closing the convertible roof top 100 is found in U.S. Pat. No. 5,785,375 to Alexander issued Jul. 28, 1998 and U.S. patent application Ser. No. 10/836,322, filed Apr. 30, 2004, which are incorporated herein by reference.

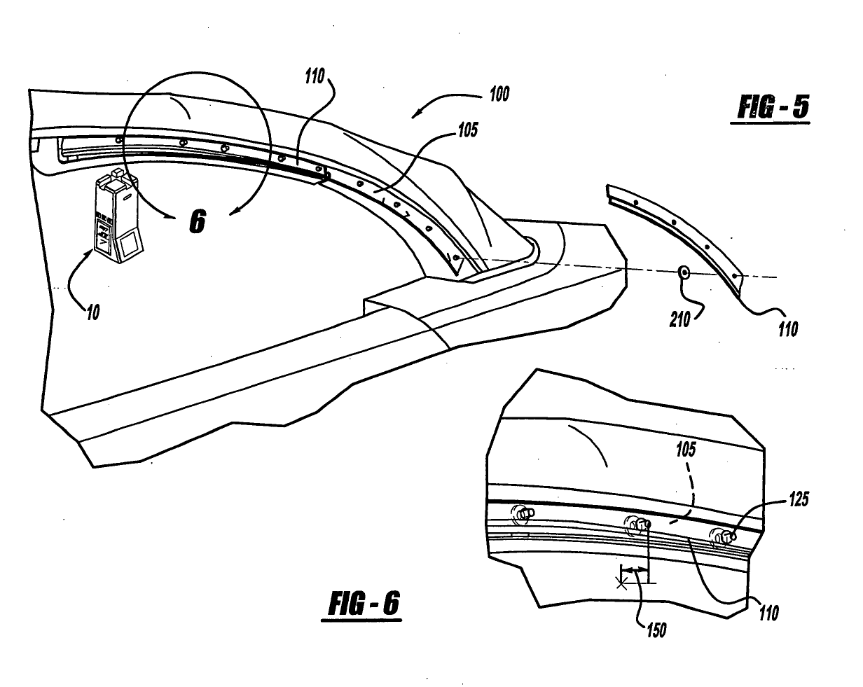

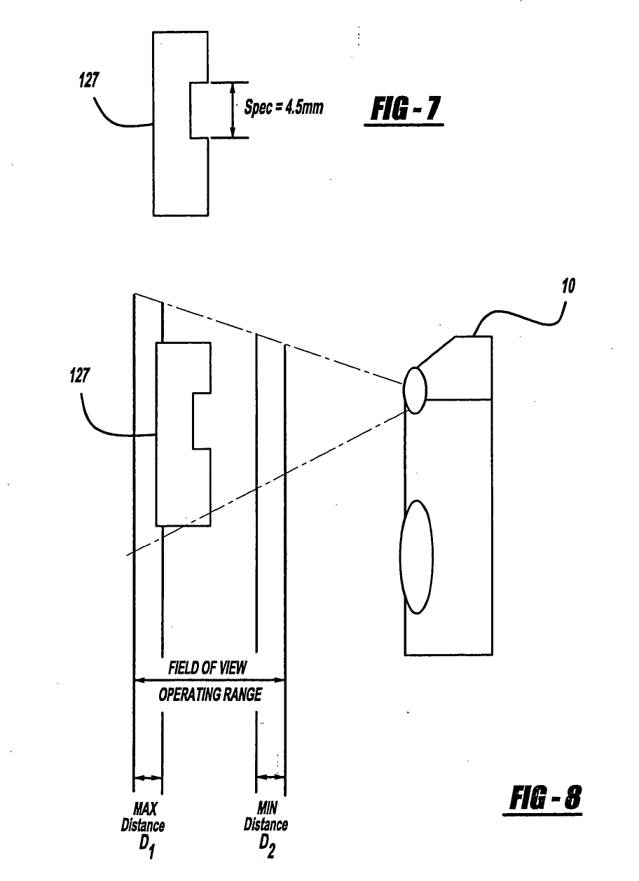

FIGS. 3-6 exemplify measuring a gap 150 between a side rail casting 105 and a weather strip retainer 110 that is needed to properly close a convertible roof 100. FIG. 4 illustrates an enlarged view of the side rail casting 105 with securing elements 125 protruding through apertures in the side rail casting 105. As shown in FIG. 5, the measurement device 10 is pointed in the direction between the side rail casting 105 and the weather strip retainer 110. In this position, the measurement device 10 is able to measure the gap 150, shown in FIG. 6, which is necessary to allow the convertible roof 100 to properly close.

The boundaries of the gap 150 of FIG. 6 are firmly established by placing a shim(s) 210 between the side rail casting 105 and the weather strip retainer 110. The number of shims 210 that are used to ensure the width of this gap 150 depends upon obtaining accurate measurement data. After the weather strip retainer 110 is properly secured through securing elements 125 to the side rail castings 105, a weather strip (not shown) is mounted to the weather strip retainer 110.

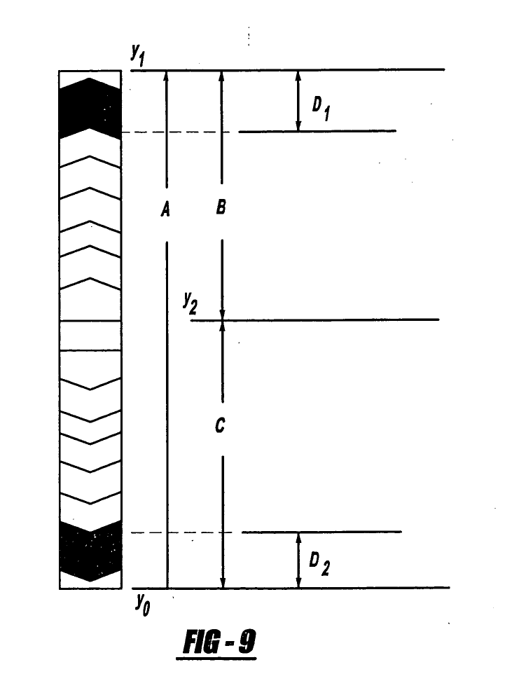

FIGS. 7-8 more clearly illustrate a gap in workpiece 127 that is measured by the measurement device 10. The maximum and minimum warning distance ranges D1 and D2, respectively, are shown relative to the beam projected from the measurement device 10.

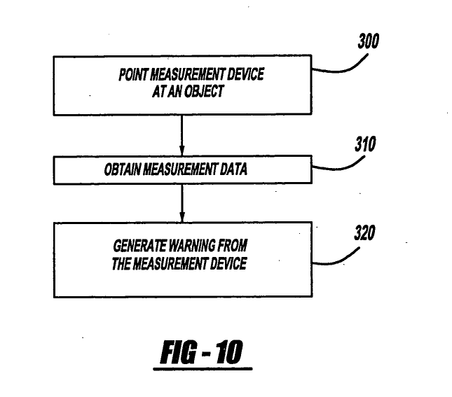

FIG. 9 is a block diagram of a scanning system range for a measurement device 10. “A” represents the entire operating range that extends from y₀ to y₁ for the measurement device 10. “B”, which extends from position y₂ to y₁, represents the upper portion of the operating range. “B” occurs when the measurement device 10 is moving away from the surface of the object. “C” is the lower limit range that extends from y₀ to y₂. The “C” range occurs when the measurement device 10 moves closer to the surface of the object. D1 and D2 are the maximum and the minimum warning ranges in which a warning command is issued by the control module 20 of the measurement device 10. The D1 and D2 ranges may be controlled by user input to the measurement device 10. For example, the user may set this range at 85% or greater of the operating range. Alternatively, this range may be 95% or greater. Other ranges may also be used.

FIG. 10 is a flow diagram of a method to warn a user that a measurement device is approaching a distance or an angle that prevents obtaining accurate measurement data between the measurement device and an object. The measurement device points at a surface of an object at operation 300. Measurement data is obtained at operation 310. A determination is made that a measurement device is substantially close to exceeding its operating range for obtaining accurate measurement data. A warning is issued when the measurement device is substantially close to exceeding its operating range for obtaining accurate measurement data at operation 320.

The present invention has numerous applications. For example, the measurement device 10 may be mounted onto an automatically movable robotic arm. Alternatively, the measurement device 10 may be stationarily affixed to a factory floor mounted support. Additionally, the measurement device 10 can be used to measure a variety of features (e.g., a gap, components, assembly of other soft top and hard top convertible roofs, etc.). The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An automotive system comprising:
an automotive convertible roof; and
a measuring device operably compares measurement data associated with the automotive convertible roof to an operating range for the measurement device, and to generate a message that informs a user when the measurement device is in a position which is about 15% from exceeding its operating range for obtaining accurate data.

2. The automotive system of claim 1, wherein the measurement device projects a laser beam onto the automotive convertible roof.

3. The automotive system of claim 1, wherein the message is selected from the group consisting essentially of an audible warning, a visual warning, and a physical warning.

4. The method of claim 3, wherein the physical warning is a vibrating motion of the measurement device.

5. The method of claim 3, wherein the audible warning includes a verbal warning that the measurement device is exceeding its operating range.

6. A system comprising:
an automotive convertible roof; and
a measuring device comprising:
a control module operably controlling an operation of the measurement device;
a non-contact sensor operably obtaining image data associated with the automotive convertible roof, the non-contact sensor coupled to the control module;
an image processor operably converting image data to measurement data, the image processor coupled to the control module;
a memory coupled to the control module, the memory stores an operating range for the measurement device;
wherein the control module operably compares the measurement data to an operating range of the measurement device, and to generate a message that informs a user when the measurement device is in a position which is above 15% from exceeding its operating range for obtaining accurate data.

7. The system of claim 6, wherein the measurement device projects a laser beam onto the automotive convertible roof.

8. The system of claim 6, wherein the message is selected from the group consisting essentially of an audible warning, a visual warning, and a physical warning.

9. An automotive system for comprising:
an automotive convertible roof having a gap between a side rail casting and a weather strip retainer; and
a measuring device operably obtains data associated with the gap, and to compare measurement data associated with the gap to an operating range for the measurement device, and to generate a message that informs a user when the measurement device is in a position which is about 15% from exceeding its operating range for obtaining accurate data.

10. The automotive system of claim 9, wherein the measurement device projects a laser beam onto the automotive convertible roof.

11. The automotive system of claim 9, wherein the message is selected from the group consisting essentially of an audible warning, a visual warning, and a physical warning.

12. An apparatus comprising:
storage media including instructions stored thereon which when executed cause a measurement device to perform a method including:
measuring one of an angle and a distance between the measurer and an object; and
generating a message that warns a user of the measurer when it is substantially close to exceeding its operating range for obtaining accurate measurement data.

13. The apparatus of claim 12, wherein the message is selected from the group consisting essentially of an audible warning, a visual warning, and a physical warning.

14. The apparatus of claim 13, wherein the physical warning is a vibrating motion of the measurement device.

15. The apparatus of claim 13, wherein the audible warning includes a verbal warning that the measurement device is exceeding its operating range.

16. The apparatus of claim 12, wherein the method further comprises:
comparing one of a measured angle and a distance to an operating range for the measurement device.

17. A measurement device comprising:
a control module operably controlling an operation of the measurement device;
a non-contact sensor operably obtaining image data, the non-contact sensor coupled to the control module;
an image processor operably converting image data to measurement data, the image processor coupled to the control module;
a memory coupled to the control module, the memory operably storing an operating range for the measurement device;
wherein the control module is configured to compare the measurement data to an operating range of the measurement device, and to generate a warning message when the measurement device is about 15% from exceeding its operating range for obtaining accurate data.

18. An assembly method using a measurement device, the method comprising:
pointing the measurement device at the object;
measuring at least one of an angle and a distance, between the measurement device and the object; and
generating a message that informs a user when the measurement device is substantially close to exceeding its operating range for obtaining accurate measurement data.

19. The method of claim 18, wherein the message is selected from the group consisting essentially of an audible warning, a visual warning, and a physical warning.

20. The method of claim 19, wherein the physical warning is a vibrating motion of the measurement device.

21. The method of claim 19, wherein the audible warning includes a verbal warning that the measurement device is exceeding its operating range.

22. The method of claim 18 further comprising:
comparing one of a measured angle and a distance to an operating range for the measurement device.

23. The method of claim 18, wherein substantially close is defined at about 15% to one of an upper limit and a lower limit of the operating range.

24. The method of claim 18, wherein substantially close is defined at about 5% to one of an upper limit and a lower limit of the operating range.

25. The method of claim 18, wherein the object is a component of a convertible roof of an automotive vehicle.

26. The method of claim 18 further comprising projecting a laser beam onto the object and optically sensing the projected laser beam on the object.

27. A vehicle assembly method using a convertible roof and a measurer, the method comprising:
assembling the convertible roof;
pointing the measurer at a surface of the convertible roof;
measuring at least one of a distance and an angle, between the measurer and the surface;
comparing at least one of the measured distance and the angle, to an operating range for the measurer; and
informing a user when the measurer is substantially close to exceeding its operating range for obtaining accurate measurement data.

28. The method of claim 27, wherein the message is selected from the group consisting of an audible warning, a visual warning, and a physical warning.

29. The method of claim 27, wherein the physical warning is a vibrating motion of the measurement device.

30. The method of claim 28, wherein the audible warning includes a verbal warning that the measurement device is exceeding its operating range.

31. The method of claim 27, wherein the measurer measures a gap between a side rail casting and a weather strip retainer.

32. The method of claim 27, wherein substantially close is about 15% to one of an upper limit and a lower limit of the operating range for the measurement device.

33. The method of claim 27, wherein substantially close is about a 5% to one of an upper limit and a lower limit of the operating range for the measurement device.

34. The method of claim 27 further comprises measuring the relationship of a side rail component and a weatherstrip of the convertible roof.

35. The method of claim 27 further comprises projecting a laser beam onto the object and optically sensing the projected laser beam on the object.

36. A method to warn a user that a measurement device is approaching a distance from an object that prevents obtaining accurate measurement data between a measurement device and the object, the method comprising:
pointing a measurement device at a surface of an object;
determining that a first distance exists between the measurement device and the object;
moving the measurement device to a second distance from the object; and
generating a warning that indicates that the measurement device is closely approaching one of an upper limit and a lower limit for an operating range of the measurement device.

37. The method of claim 36, wherein the warning is selected from the group consisting of an audible warning, a visual warning, and a physical warning.

38. The method of claim 37, wherein the audio warning is a verbal message.

39. The method of claim 36, wherein substantially close to exceeding its operating range is about 15% to one of an upper limit and a lower limit of the operating range.

40. The method of claim 36 wherein substantially close to exceeding its operating range is about 5% to one of an upper limit and a lower limit of the operating range.

41. A method for manufacturing a measurement device used in vehicle assembly comprising:
controlling an operation of the measurement device through a control module;
coupling a non-contact sensor to the control module;
coupling an image processor to the control module; and
coupling a memory to the control module,
wherein the control module operably compares measurement data to an operating range of the measurement device, and to generate a warning message when the measurement device is substantially close to exceeding its operating range for obtaining accurate data.

42. A measurement device used in vehicle assembly comprising:
a control module operably controlling an operation of the measurement device;
a non-contact sensor operably obtaining image data, the non-contact sensor being coupled to the control module;
an image processor operably converting image data to measurement data, the image processor coupled to the control module;
a memory coupled to the control module, the memory operably storing an operating range for the measurement device;
a display coupled to the control module;
wherein the control module is configured to compare the measurement data to an operating range of the measurement device, and to generate a warning message when the measurement device is substantially close to exceeding its operating range for obtaining accurate data.

43. The measurement device of claim 42 wherein the warning is selected from the group consisting of an audible warning, a visual warning, and a physical warning.

44. The measurement device of claim 42 wherein the physical warning is a vibrating motion of the measurement device.

45. The measurement device claim 43 wherein the audible warning includes a verbal warning that the measurement device is exceeding its operating range.

46. The measurement device of claim 42, wherein the measurement device measures one of an angle and a distance between the measurement device and the object.

47. The measurement device of claim 42, wherein substantially close to exceeding its operating range is about 15% to one of an upper limit and a lower limit of the operating range.

48. The measurement device of claim 42, wherein substantially close to exceeding its operating range is about a 5% to one of an upper limit and a lower limit of the operating range.

49. An assembly method as applied to a convertible roof using a measurement device, the method comprising:
pointing the measurement device at an object;
measuring at least one of an angle and a distance, between the measurement device and the object; and
generating a message that warns a user when the measurement device is substantially close to exceeding its operating range for obtaining accurate measurement data.
